(19) United States
(12) Patent Application Publication
(10) Pub. No.: US 2025/0205684 A2
(43) Pub. Date: Jun. 26, 2025

(54) METHOD FOR PROCESSING ALUMINUM-BASED DRINKING WATER TREATMENT RESIDUALS TO GENERATE A GREEN-ENGINEERED MULCH FOR REMOVING STORMWATER POLLUTANTS

(71) Applicant: The Trustees of the Stevens Institute of Technology, Hoboken, NJ (US)

(72) Inventors: Dibyendu Sarkar, West Orange, NJ (US); Viravid Na Nagara, Jersey City, NJ (US); Rupali Datta, Houghton, MI (US)

(73) Assignee: The Trustees of the Stevens Institute of Technology, Hoboken, NJ (US)

(21) Appl. No.: 18/698,745

(22) PCT Filed: Oct. 11, 2022
(86) PCT No.: PCT/US2022/077911

§ 371 Date: Apr. 4, 2024

Related U.S. Application Data
(60) Provisional application No. 63/254,513, filed on Oct. 11, 2021.

(51) Int. Cl. B01J 20/32; B01J 20/02; B01J 20/24; B01J 20/30; C02F 1/28; C02F 101/20; C02F 103/00

(52) U.S. Cl. CPC B01J 20/3282; B01J 20/0248; B01J 20/24; B01J 20/3071; B01J 20/3206; C02F 1/288; C02F 1/281; C02F 1/286; C02F 2101/20; C02F 2103/001

(57) ABSTRACT

A green-engineered mulch product and methods for making same are disclosed. The mulch product includes a coating of aluminum-based water treatment residuals which makes the product “green.” Furthermore, coating aluminum-based water treatment residuals on mulch eliminates the problem of the low hydraulic conductivity of aluminum-based water treatment residuals and makes it feasible to utilize its pollutant removal potential without requiring any modification to existing best management practices or additional maintenance.

### CROSS REFERENCE TO RELATED APPLICATIONS

This is an application under 35 U.S.C. § 371 of International Application No. PCT/US2022/077911 filed Oct. 11, 2022, and entitled, “METHOD FOR PROCESSING ALUMINUM-BASED DRINKING WATER TREATMENT RESIDUALS TO GENERATE A GREEN-ENGINEERED MULCH FOR REMOVING STORMWATER POLLUTANTS,” which claims priority to U.S. Provisional Patent Application Ser. No. 63/254,513 filed Oct. 11, 2021, the entireties of all of which applications being incorporated herein by reference when and where permissible.

### STATEMENT REGARDING FEDERALLY SPONSORED RESEARCH

This invention was made with government support under Grant No. NA180AR4170087 awarded by the National Oceanic and Atmosphere Administration (NOAA). The U.S. government has certain rights in the invention.

### FIELD OF THE INVENTION

The present invention pertains to the treatment of stormwater. In particular, it relates to the production of a filter media made of mulch and aluminum-based water treatment residuals (Al-WTR) generated from drinking water treatment process.

### BACKGROUND OF THE INVENTION

Stormwater pollution is a major source of water body impairment. Various types of stormwater best management practices (BMPs) have been developed and implemented. While stormwater quantity reduction is the primary function of most stormwater BMPs to mitigate flooding, their capability in addressing stormwater pollution is limited. Different amendment materials and complicated design elements have been developed and integrated into bioretention systems to enhance their pollutant removal performance. However, such approaches require a significant amount of resources, labor, and expertise for design, implementation, and maintenance. Moreover, stormwater treatment technologies currently in use generally require significant land alteration, complicated design, and extensive construction, which are all expensive.

Stormwater runoff is a major source of water pollution, particularly in urbanized areas. Among the various pollutants that are washed off by stormwater, metals are considered major contributors in an urban setting. Metals have significant ecotoxic impacts on the environment. Implementation of cost-effective, sustainable, “green” technologies for metal removal from stormwater can minimize negative environmental and human health impacts.

Al-WTR is an industrial byproduct from drinking water treatment processes where aluminum salts are used as primary coagulants. Al-WTR is freely available and inherently effective in removing metals and nutrients. However, Al-WTR has low hydraulic conductivity, which poses a challenge for utilizing it as a retrofitting material. Therefore, a processing protocol is required to increase hydraulic conductivity so that its capacity to adsorb pollutants could be utilized.

### SUMMARY OF THE INVENTION

After acquiring Al-WTR from drinking water treatment facilities, the Al-WTR is subjected to tests to evaluate its toxicity and contaminant removal potential to ensure that the material is non-hazardous and meets the reactivity performance criteria, respectively. Once the non-toxicity and reactivity requirements are met, the Al-WTR can be ground into a fine powder. The powder is subsequently mixed with a biopolymer solution, such as alginate. Mulch chips are then coated by soaking them in the solution. The coated mulch is then added individually into an ionic cross-linker, such as calcium, to produce a green engineered mulch product. Since mulch is a commonly used material in stormwater BMPs, especially bioretention systems, coating Al-WTR on mulch eliminates the problem of the very low hydraulic conductivity of Al-WTR and makes it feasible to utilize its pollutant removal potential without requiring any modification to existing BMPs or additional maintenance. The green engineered mulch can serve as an alternative to regular mulch to enhance pollutant removal performance of stormwater BMPs, such as bioretention systems. The use of green engineered mulch is a simple, cost-efficient, environmentally friendly, and effective approach to combat stormwater pollution with minimal energy input and organic materials. In addition to mulch, the method of the present invention can be extended to coating other materials.

An object of the present invention is to enhance contaminant removal without requiring significant modification and maintenance of the existing stormwater BMPs.

Another object is to provide cost-effective retrofitting material by processing Al-WTR with organic materials that help to avoid secondary environmental impacts.

A further object of the present invention is to facilitate the removal of stormwater pollutants, such as metals and nutrients, by functioning as a retrofitting material for stormwater BMPs to enhance their stormwater treatment performance.

Yet another object of the present invention is to provide green engineered mulch that can minimize stormwater pollution, a major source of water body impairment which causes not only environmental problems but also leads to economic and social challenges.

A still further object of the present invention is to provide green engineered mulch that can be implemented by anyone familiar with stormwater BMPs without the need for additional expertise.

Another object of the present invention is to provide a mulch in the that has Al-WTR in the form and geometry of a coating that does not allow water to pass.

A not-necessarily-final object of the present invention is to provide a green engineered mulch that can be substituted for regular mulch without the need for construction or engineering design adaptations and that can be easily removed once saturation is reached and replaced (e.g., with another batch of green engineered mulch).

In one embodiment a method for preparing a green product capable of removing contaminants from, for instance, stormwater is performed by grinding aluminum-based water treatment residuals into a powder, which includes ground aluminum-based water treatment residuals, mixing the powder with a biopolymer solution to make a coating solution, coating mulch chips with the coating solution to create coated mulch chips, and adding the coated mulch chips into an ionic crosslinker, thereby creating the green product of interest.

The method mentioned above can also involve the step of evaluating the aluminum-based water treatment residuals for toxicity before grinding them. The ground aluminum-based water treatment residuals can also be evaluated for toxicity after grinding. The aluminum-based water treatment residuals can also be dried prior to the grinding step. The aluminum-based water treatment residuals can also be evaluated in advance of the manufacturing process for their potential to remove contaminants from stormwater. Another further manufacturing step can involve sieving the ground aluminum-based water treatment residuals through, for instance, a 1-mm sieve. In another embodiment the ground aluminum-based water treatment residuals can be washed with acid (e.g., acetic acid). In further embodiments, the inventive method can include the step of washing and/or drying the green product.

In some embodiments, the inventive process can further include the step of evaluating the ground aluminum-based water treatment residuals for their sorbent/reactivity potential. This can be done by testing for oxalate-extractable aluminum concentration. Another way this can be done is measuring the concentration of amorphous aluminum hydroxide in the ground aluminum-based water treatment residuals. In another embodiment, the step of measuring the concentration of amorphous aluminum oxide in said ground aluminum-based water treatment residuals can be performed towards the end of evaluating sorbent potential.

In an embodiment, the aluminum-based water treatment residuals can include aluminum salts. In another embodiment, the biopolymer solution can be alginate-based. Alternatives include biopolymer solutions comprising chitosan, pectin and gellan gum. The ground aluminum-based water treatment residuals may be added at the ratio of 15% weight/volume to 2% weight/volume alginate biopolymer solution. In one embodiment, the mulch chips are provided for the performance of the coating step at a ratio of 45% weight/volume.

In an embodiment, the ionic crosslinker can be a solution which includes calcium, which can be prepared by dissolving 6% weight/volume eggshell powder in 10% volume/volume acetic acid during the preparation of the ionic crosslinker.

The method can be performed in conjunction with the further step of applying said green product on the ground of a bioretention system or retrofitting stormwater best management processes by replacing regular mulch with the green product. In some embodiments, the resultant green-engineered mulch product is a coating adapted for application to mulch chips and the like that includes a biopolymer, ground aluminum-based water treatment residuals and an ionic crosslinker binding the biopolymer and the ground aluminum-based water treatment residuals together. In other embodiments, the resultant product is a combination of the coating and mulch chips applied to the coating at a ratio of 45% weight/volume.

In an embodiment, the coating does not allow water to pass through it. The coating can contain, for instance, alginate, chitosan, pectin or gellan gum as the biopolymer. The ionic cross-linker can contain calcium.

### BRIEF DESCRIPTION OF THE FIGURES

For a more complete understanding of the present invention, reference is made to the following figures, in which:

FIG. 1 is a flow chart of the invention being assembled;

FIG. 2 is a production flow chart for generating green engineered mulch;

FIG. 3 depicts linearized Freundlich Isotherms for Cu, Pb, Zn, and P;

FIG. 4a-4d disclose results for a kinetic experiment for P (see FIG. 4a), Cu (see FIG. 4b), Pb (see FIG. 4c), and Zn (see FIG. 4d); and

FIG. 5 discloses the respective results for a column study.

### DETAILED DESCRIPTION OF THE EXEMPLARY EMBODIMENTS

Reference will now be made to various embodiments of the present invention(s), examples of which are illustrated in the accompanying figures. Wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

All terms defined herein should be afforded their broadest possible interpretation, including any implied meanings as dictated by a reading of the specification as well as any words that a person having skill in the art and/or a dictionary, treatise, or similar authority would assign thereto.

The terms, “for example”, “e.g.”, “optionally”, as used herein, are intended to be used to introduce non-limiting examples. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.” In addition, the terms “comprises” and “comprising” when used herein specify that certain features are present in that embodiment; however, these terms should not be interpreted to preclude the presence or addition of additional steps, operations, features, components, and/or groups thereof.

With the foregoing prefatory comments in mind, the present invention involves a combination of an inexpensive industrial byproduct (i.e., aluminum-based water treatment residuals, Al-WTR), which is inherently effective in metal and nutrient removal, together with mulch, a common material applied in many traditional stormwater BMPs, by processing through a simple protocol that requires minimal energy input and organic materials.

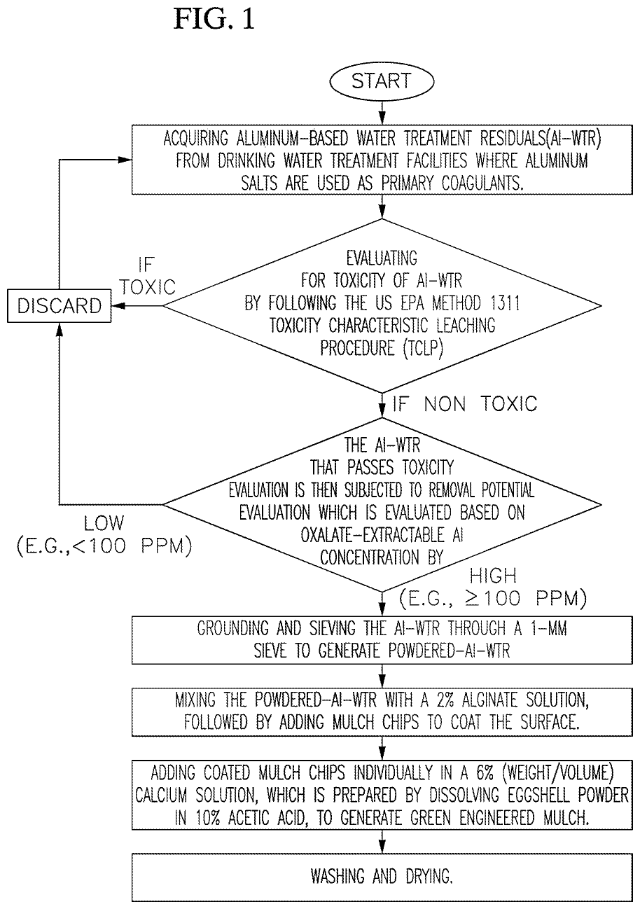

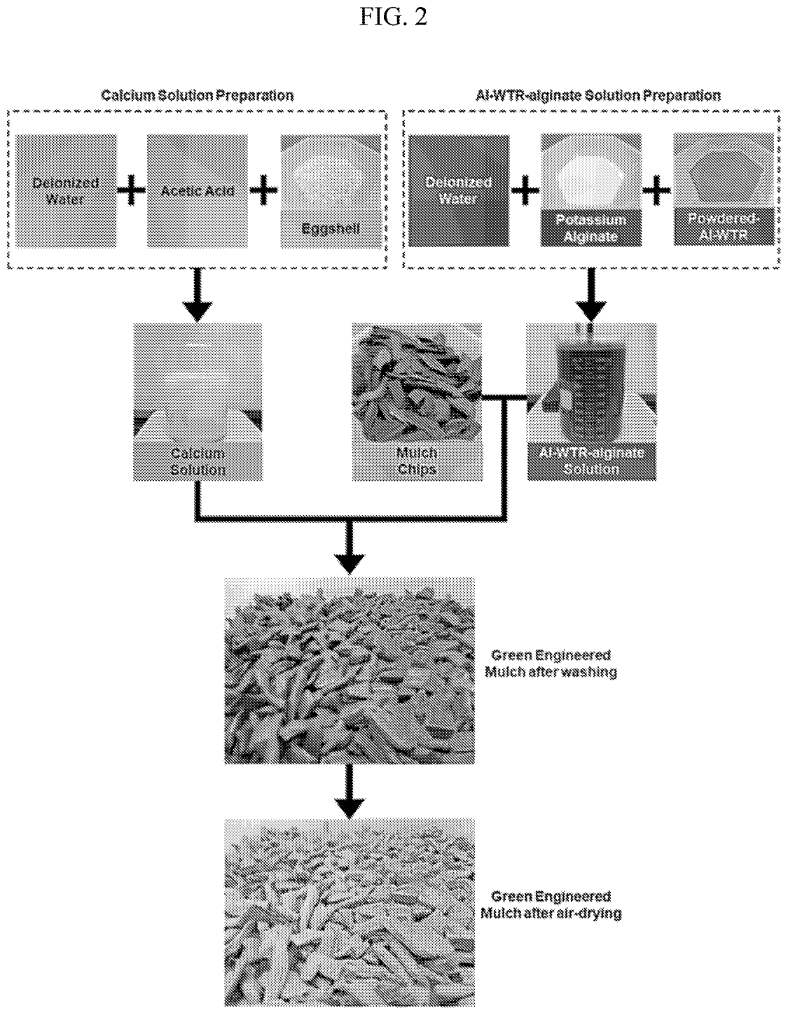

The inventive method is depicted in FIGS. 1 and 2 and initially involves acquiring aluminum-based water treatment residuals (Al-WTR) from drinking water treatment facilities where aluminum salts are used as primary coagulants. The toxicity of Al-WTR can then be determined by following the US EPA Method 1311 Toxicity Characteristic Leaching Procedure (TCLP). If toxic, the Al-WTR can be discarded; otherwise the process can continue. Any Al-WTR that passes toxicity evaluation is then subjected to removal potential evaluation which is evaluated based on oxalate-extractable Al concentration by extracting with 0.2M oxalate solution. If it is low potential (e.g., <100 ppm), it can be discarded. If it is high potential (e.g., ≥100 ppm), the process can continue with grounding and sieving the Al-WTR through a 1-mm sieve to generate powdered-Al-WTR. Subsequently, the powdered-Al-WTR is mixed with an alginate solution (e.g., 2% w/v), followed by adding mulch chips to coat the surface. From there, coated mulch chips can be added individually in a calcium solution (e.g., 6% w/v), which is prepared by dissolving eggshell powder in acetic acid (e.g., 10% v/v), to generate green engineered mulch, followed by washing and drying.

To ensure the Al-WTR provided is suitable for application as an environmentally friendly (i.e., non-hazardous) sorbent, it can be evaluated for potential toxicity using the Toxicity Characteristic Leaching Procedure (TCLP) method (US EPA Method 1311). Such a procedure may be implemented by first adding 5 g of Al-WTR with a particle size of approximately 1 mm in diameter or less to 96.5 mL of deionized water in a beaker, covering the beaker with a watch glass, and stirring the beaker's contents with a magnetic stirrer.

If the pH of the resultant Al-WTR slurry is less than 5.0, then a first extraction fluid is used, which can be prepared by adding 5.7 mL glacial acetic acid to 500 mL of deionized water, followed by adding 64.3 mL of 1M NaOH and diluting to 1 L. The first extraction fluid will have a pH of 4.93±0.05 when properly prepared.

On the other hand, if the measured pH is more than 5.0, the Al-WTR slurry is mixed with 3.5 mL 1M, HCl, covered with a watch glass, heated to 50° C., and held at 50° C. for 10 min. After the solution cools to room temperature, the pH is recorded. If the pH is less than 5.0, the first extraction fluid is used; otherwise a second extraction fluid is used, which can be prepared by diluting 5.7 mL of glacial acetic acid to 1 L with deionized water. The pH of the second extraction fluid will be 2.88±0.05 when properly prepared.

To test toxicity in accordance with the aforementioned protocol, 3 aliquots of 100 grams of dried and sieved Al-WTR can be added to a vessel (e.g., an extractor bottle). In an embodiment, 2 L of extraction fluid is added to the vessel, which can then be shaken (e.g., at 28-32 rpm for 16-20 hours in a rotary shaker). It will be appreciated by those skilled in the art that the shaking step, as well as any shaking or stirring step described subsequently, can be conducted at any appropriate frequency that is sufficient to homogenize the solution without causing loss of sample or solution. The vessel's contents are then filtered (e.g., with a glass fiber filter) and the sample can be evaluated for the presence of the eight toxic heavy metals set forth by the Resource Conservation and Recovery Act (RCRA 8). The concentrations of RCRA 8 metals in the extracts can be evaluated against regulatory levels to determine whether the Al-WTR is non-hazardous. If, for any RCRA 8 metal, the concentration is at 80%, or higher of the prescribed regulatory level, the Al-WTR can he washed with 10% (volume/volume) acetic acid, which can be prepared by diluting concentrated vinegar with distilled water. After washing, the Al-WTR is subject to the same TCLP process, beginning with the addition of the extraction fluid. This is repeated as necessary until it can be verified that the metal concentrations have gone below the acceptable level. The TCLP values for toxic metals for a representative Al-WTR used as source materials in an embodiment of the invention are well below the hazardous waste toxicity characteristic criteria as defined in Title 40 of the Code of Federal Regulations (CFR), Part 261.24.

Once the Al-WTR is deemed non-hazardous, its potential effectiveness as a sorbent is determined by measuring the concentration of amorphous Al oxide or Al hydroxide, which are expected to provide the majority sites for metal and phosphate and sulfate sorption. Amorphous oxides/hydroxides are desirable as they have significantly higher specific surface area than the corresponding crystalline structures. Amorphous Al oxide/hydroxide can be extracted using the ammonium oxalate method disclosed in Jackson, M. L., Lim, C. H., & Zelazny, L. W. (1986). Oxides, Hydroxides, and Aluminosilicates. Methods of Soil Analysis: Part 1—Physical and Mineralogical Methods, 101-150.

Oven-dried and sieved Al-WTR (0.25 g) can be added to a 100-mL polypropylene centrifuge tube, followed by addition of 50 mL of 0.2 M ammonium oxalate solution adjusted to pH 3.0 using NH₄OH or HCL. The centrifuge tube may be capped and wrapped with aluminum foil to eliminate light. The mixture can subsequently be shaken for 2 hours in the dark on a reciprocating shaker and then centrifuged. Next, the supernatant may be analyzed for Al. In an embodiment, the Al-WTR is only used for generating granulated sorbent media if the oxalate-extractable Al concentration exceeds a certain threshold concentration (e.g., 100 ppm).

Once ground to the appropriate size, the granulated Al-WTR product may be formed. In an embodiment, a biopolymer solution will be prepared. The biopolymer can be either alginate, chitosan, pectin or gellan gum. If alginate is chosen as the biopolymer, a 2% (weight/volume) alginate solution may be prepared by mixing 10 g of potassium alginate in 500 mL of distilled deionized water and stirring for 1 hour. After the preparation of the alginate solution, 75 g of powdered-Al-WTR can be added to the solution and stirred for 10 hours following which a crosslinked polymer mesh is created.

To create a crosslinked polymer mesh, calcium ions are used as an ionic cross-linker. In an embodiment, a 6% (weight/volume) calcium solution is prepared by mixing (e.g., by stirring for 1 hour) commercially available eggshell powder in 10% (volume/volume) acetic acid solution, which is prepared by diluting concentrated vinegar with distilled water. Al-WTR-alginate solution may be added dropwise in the calcium solution to produce Al-WTR granules, which are left in the solution for 4 hours and then washed with distilled water several times to remove excess calcium solution. The washed granules can finally be air-dried or oven-dried at low temperature (e.g., at 45° C. for 24 hours). With the addition of calcium and potassium alginate as such, a hardened shell is formed that entraps Al-WTR powder.

Overall, based on waste-to-resource and circular economy principles, a waste by-product from drinking water treatment plants, namely, aluminum-based water treatment residuals (WTR) were utilized to generate a granulated filter media for stormwater treatment. Because the WTR granules are generated from a non-hazardous waste (verified using TCLP following USEPA Method 1311) and organic materials, they are considered “green” from both ecologic and economic standpoints. Further details involving the preparation and evaluation of toxicity and removal potential of Aluminum-based water treatment residuals (Al-WTR) are contained in U.S. Patent Publication No. 2020/0316556A1, the entire contents of which are incorporated herein by reference and made a part of the present application for all purposes.

Briefly, any drinking water treatment facilities that use aluminum salts as primary coagulants can serve as a source of Al-WTR for this process. Prior to evaluation and processing, the moisture of the raw Al-WTR can be removed by air-drying or heating at 105° C. for 24 hours in an oven. For toxicity evaluation, the Toxicity Characteristic Leaching Procedure (TCLP) method (US EPA Method 1311-see Appendix B) is followed. The resulting extract from the aforementioned method is subsequently evaluated for the presence of eight toxic metals as specified in the Resource Conservation and Recovery Act (RCRA 8) by comparing with the regulatory levels. After the toxicity requirements are satisfied, the concentration of amorphous Al oxide or Al hydroxide, which is considered a removal potential indicator, is determined using the ammonium oxalate method as stated in the aforementioned Jackson et al. 1986 publication. Al-WTR that meets the threshold concentration of oxalate-extractable Al of 100 ppm can be used for generating the green engineered mulch.

A similar preparation method as outlined above and in the aforementioned 2020/0316556 Publication can be followed after passing the toxicity and removal potential evaluations. In short, the dried Al-WTR is ground and sieved through a 1-mm sieve to generate powdered-Al-WTR. The powdered Al-WTR is then added into a solution of biopolymer such as chitosan, pectin, alginate, etc. In this manner, by using binders in this category of biopolymers, an entirely green process can be achieved starting from the base material (i.e., mulch) and including the binder. To prepare a biopolymer solution made from alginate, potassium alginate (20 g) is added slowly into vigorously stirred deionized water (1000 mL). After 1 hour of continuous stirring, the powdered-Al-WTR (150 g) is mixed into the solution. The solution is then continuously stirred for 3 hours to achieve a homogenous mixture. Then, 450 g of mulch chips of approximate size (10 mm×20 mm) that is dried after rinsing with deionized water is mixed into the solution and coated thoroughly. The mulch chips are soaked in the solution for approximately 1 hour to ensure maximum coverage on the surface. To prepare a calcium solution, concentrated acetic acid is diluted to a 10% (volume/volume) solution with deionized water, followed by the addition of commercially available egg shell powder at a concentration of 6% (weight/volume), and stirred for 1 hour. The coated mulch chips are then added to the calcium solution. When the coated mulch chips come into contact with the calcium solution, a cross-linked polymer mesh that entraps Al-WTR as a layer on the surfaces of the mulch chips is formed. During this step, the coated mulch chips are added individually into the calcium solution, which is gently shaken to prevent aggregation of the green engineered mulch which may diminish surface area and lower the removal performance. After the green engineered mulch is soaked in the calcium solution for 3 hours, several cycles of washing and soaking in deionized water are performed to remove excess calcium solution. The green engineered mulch is then subjected to drying, which can be done by air-drying or heating in an oven at a low temperature such as at 45° C. for 24 hours.

The green engineered mulch generated from this process is economical and environmentally safe. The green engineered mulch can be applied on soil or in vegetated areas, especially bioretention systems that receive stormwater runoff to enhance removal of stormwater pollutants such as metals and nutrients. The green engineered mulch, the product of the present invention, is designed for use as a retrofit material for stormwater best management practices. For example, the present invention may be applied on the ground of bioretention systems such as rain gardens, bioswale, stormwater planters, tree filter boxes, etc. to remove pollutants such as nutrients and metals from stormwater runoff before it infiltrates into the ground or flows to streams or rivers. The present invention is also inexpensive and can be used to retrofit stormwater BMPs by simply applying it on soil or vegetation areas in place of regular mulch, without requiring modification of designs or areas. Spent mulch can be replaced by scooping the old batch up and applying a fresh batch. The implementation and maintenance can be done by anyone who is familiar with stormwater BMPs without additional expertise. The invention can serve as an inexpensive approach that can be implemented and maintained by municipality personnel or landowners themselves. Because it is made from mulch, organic materials, and Al-WTR which is non-hazardous, the chance of causing secondary environmental impacts is minimal.

### Adsorption Isotherm Experiment

To determine equilibrium adsorption parameters of the green engineered mulch, adsorption isotherm experimentation was conducted. The green engineered mulch (4% w/v) was loaded in 50-mL centrifuge tubes with 20 mL of synthetic stormwater. Each target pollutant (P, Cu, Pb, and Zn) was prepared at varying concentrations in separate sets using Na2HPO4, Cu(NO3)2·2.5H2O, Pb(NO3)2, and Zn(NO3)2·6H2O. The pH of the solutions was adjusted to pH 7.0 using HNO3 and NaOH. Sodium nitrate (NaNO3) was used as a background electrolyte at the concentration of 0.1 M. The centrifuge tubes were shaken on a rotary shaker at 180 rpm at room temperature (23° C.±1° C.). After 24 hr of shaking, the samples were collected, filtered through a 0.45-μm nylon syringe filter, and analyzed using an inductively coupled plasma-optical emission spectrometer (ICP-OES, 5100 Agilent Technologies, CA).

### Adsorption Isotherm Experiment Results

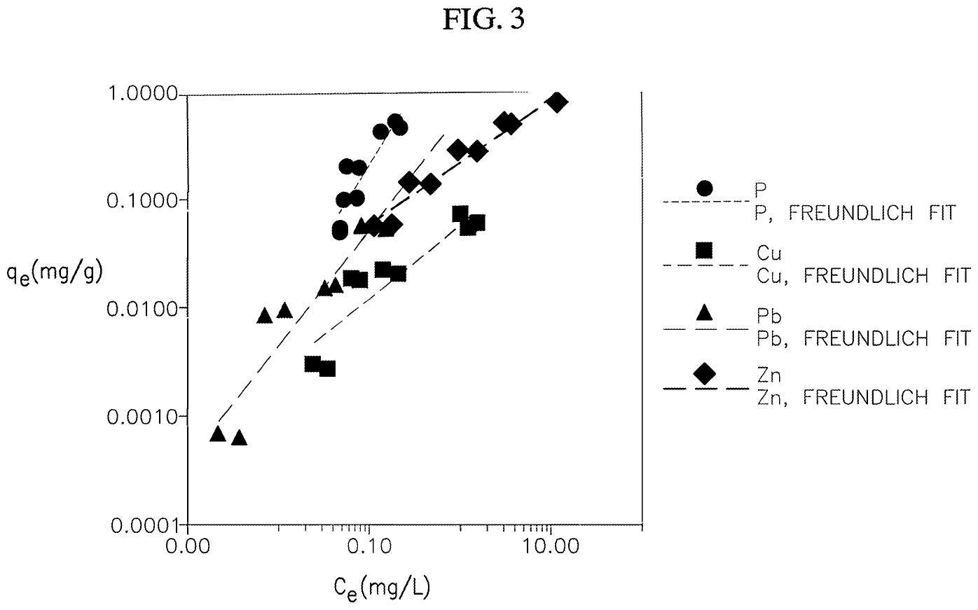

The obtained data of each target pollutant was used to calculate amount of each pollutant adsorbed by the green engineered mulch at equilibrium (qe) which is mathematically expressed as:

$${q}_{e} = \frac{( {C}_{0} - {C}_{e} ) V}{m} \times 100 \%$$

Where C0 and Ce are the initial and equilibrium concentrations of a pollutant in the solution, respectively; V is the volume of the solution; and m is the mass of the green engineered mulch. The experimental data were fitted against the Langmuir and Freundlich isotherm models. In FIG. 3, Freundlich sorption isotherms of P, Cu, Pb, and Zn on the green engineered mulch are illustrated. Symbols represent experimental data and lines are fitting curves of the Freundlich isotherm models.

The mathematical expressions of the two models are as follows:

The Langmuir isotherm model:

$${q}_{e} = \frac{{Q}_{max}^{0} {K}_{L} {C}_{e}}{1 + {K}_{L} {C}_{e}}$$

The linearized Langmuir isotherm model:

$$\frac{1}{{q}_{e}} = ( \frac{1}{{Q}_{max}^{0} {K}_{L}} ) \frac{1}{{C}_{e}} + \frac{1}{{Q}_{max}^{o}}$$

The Freundlich isotherm model:

$${q}_{e} = {K}_{F} {C}_{e}^{1 / n}$$

The linearized Freundlich isotherm model:

$$ln ( {q}_{e} ) = ln ( {K}_{F} ) + \frac{1}{n} ln ( {C}_{e} )$$

Where qₜ is the amount of each pollutant adsorbed by the green engineered mulch at time t, K_{L} is Langmuir isotherm constant, Q⁰ₘₐₓ is maximum saturated monolayer adsorption capacity of an adsorbent, K_{F} is Freundlich isotherm capacity parameter, and 1/n is Freundlich isotherm intensity parameter.

The obtained adsorption parameters and correlation coefficients R² from the two models were determined to evaluate the applicability of the isotherm equations to describe the adsorption process. For the Langmuir isotherm model, the negative values of Q⁰ₘₐₓ for P, Cu, and Pb were found, which contradicted the pollutant removal observed. Therefore, Langmuir parameters were not determined for P, Cu, and Pb. The Freundlich models provided a decent fitting for the isotherm data (R²>0.83). The experimental data of each target pollutant from the sorption isotherm study is presented in FIG. 3.

TABLE 1
Freundlich and Langmuir isotherm parameters for adsorption
of P, Cu, Pb, and Zn on the green engineered mulch.

| Target | Freundlich | | | Langmuir | | |
|---|---|---|---|---|---|---|
| Pollutant | K_{f} (μg/g) | N | R² | Q⁰ₘₐₓ (mg/g) | K_{L} (L/mg) | R² |
| P | 0.39 | 0.25 | 0.850 | — | — | — |
| Cu | 0.56 | 0.51 | 0.839 | — | — | — |
| Pb | 0.20 | 0.26 | 0.932 | — | — | — |
| Zn | 4.14 | 0.56 | 0.954 | 0.617 | 0.796 | 0.920 |

### Kinetic Experiment

A kinetic experiment was performed using similar synthetic stormwater as used in the adsorption isotherm experiment, except that the concentrations of Cu, Pb, Zn, and P were constant at the target concentrations of 100, 100, 800, 3,000 μg/L, respectively, and prepared as a multiple-pollutant solution. The green engineered mulch (4% w/v) was loaded in the synthetic stormwater (800 mL) in 1-L bottles and shaken on a rotary shaker at 180 rpm. In this study, the green engineered mulch was compared with uncoated mulch, which was used as a control. Representative samples were collected at different times during the 24-hr monitoring period, filtered through a 0.45-μm nylon syringe filter, and analyzed using the ICP-OES.

### Kinetic Experiment Results

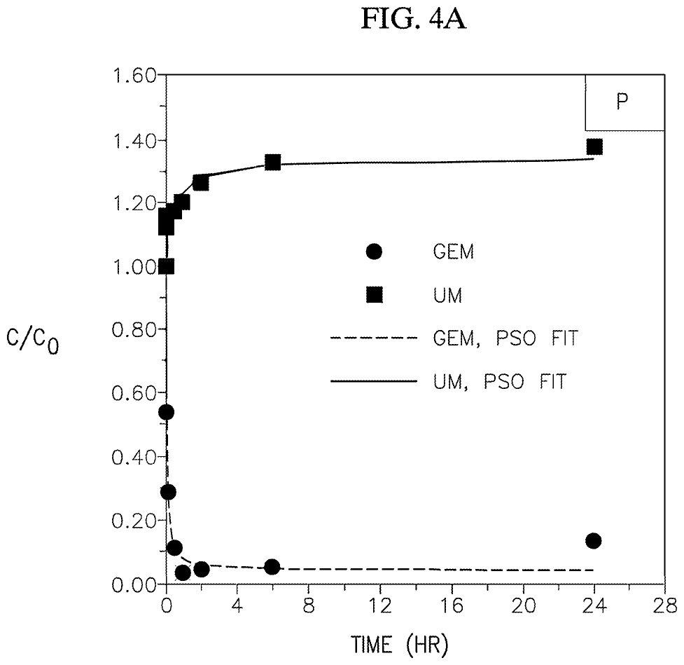

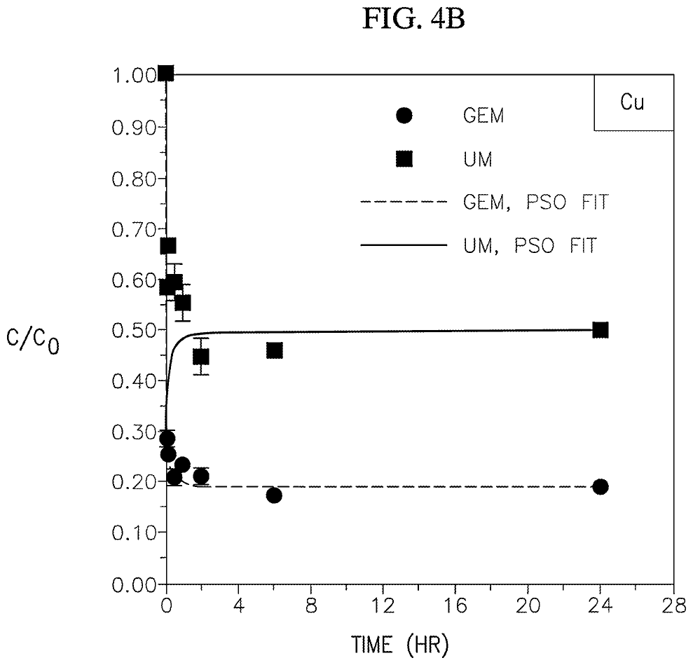

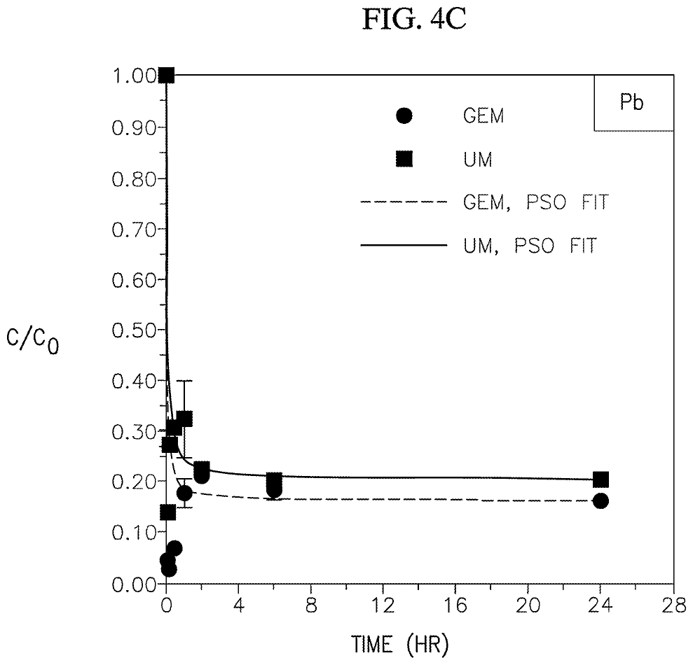

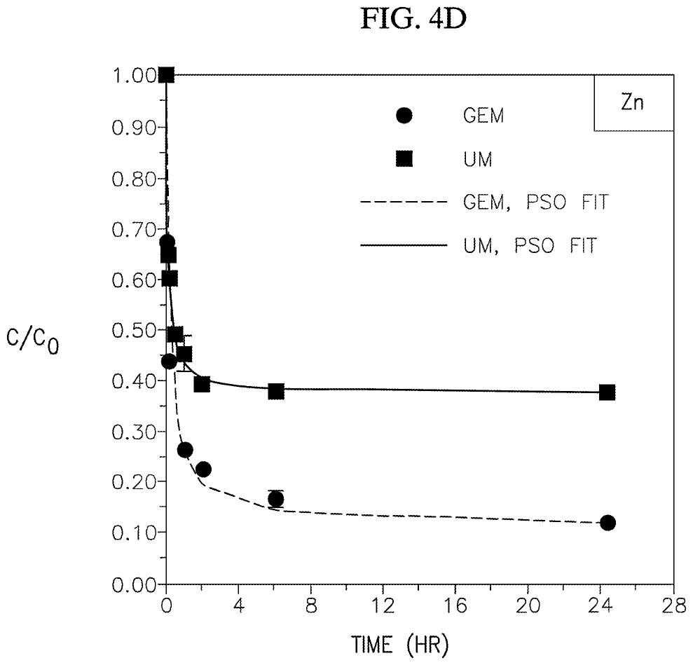

The effect of contact time on P, Cu, Pb, and Zn removal by the green engineered mulch and uncoated mulch is shown in FIG. 4. The effect of contact time on (a) P, (b) Cu, (c) Pb, and (d) Zn removal by the green engineered mulch (GEM) and uncoated mulch (UM) is shown.

With the presence of the green engineered mulch, the concentrations of the four target pollutants rapidly decreased within the first 10 minutes. The removal of P by the green engineered mulch was evidently improved compared to the uncoated mulch that released P, resulting in the increase of P concentration over time. After 5 hr, the concentrations of P, Cu, Pb, and Zn were collectively constant. The P, Cu, Pb, and Zn removal capability of the green engineered mulch was superior compared to the uncoated mulch. After 24 hr, the removal efficiency of P, Cu, Pb, and Zn by the green engineered mulch were 87%, 81%, 84%, and 88%, respectively, while the removal efficiency of Cu, Pb, and Zn by the uncoated mulch were 50%, 79%, and 62%, respectively. However, the uncoated mulch release P, resulting in an increase in the concentration of P by 38% from the initial concentration. The results showed that the green engineered mulch could remove stormwater pollutants better than the uncoated mulch, especially for P removal.

To develop mathematical models for the kinetic experiment, three kinetic models were considered: the pseudo-first-order (PFO) equation, the pseudo-second-order (PSO) equation, and the intra-particle diffusion equation. The mathematical expressions of the kinetic models are presented as follows:

The amount of each pollutant adsorbed by the green engineered mulch at time t (qₜ):

$${q}_{t} = \frac{( {C}_{0} - {C}_{t} ) V}{m}$$

The PFO equation:

$$ln ( {q}_{e} - {q}_{t} ) = - {k}_{1} t + ln ( {q}_{e} )$$

The PSO equation:

$$\frac{t}{{q}_{t}} = \frac{1}{{q}_{e}} t + \frac{1}{{k}_{2} {q}_{e}^{2}}$$

The intraparticle diffusion equation:

$${q}_{t} = {k}_{i} {t}^{0.5} + C$$

Where Cₜ are the concentrations at time t of a pollutant in the solution, V is the volume of the solution, m is the mass of the green engineered mulch, t is contact time, k₁ and k₂ are the PFO and PSO rate constants, k; is the intraparticle diffusion rate constant, and C is the intercept.

The model parameters are shown in Table 2. Among different reaction kinetics models, a PSO with respect to each pollutant best fit the experimental data with the coefficient of determination (R²) of over 0.99 for all pollutants. The modeled data of the removal of the four target pollutants on the green engineered mulch are shown in FIG. 4 along with the experimental data.

TABLE 2
Kinetic parameters for sorption of P, Cu, Pb, and
Zn on green engineered mulch and uncoated mulch.

| | | | Green engineered | Uncoated |
|---|---|---|---|---|
| Pollutant | Kinetic model | Parameter | mulch | mulch |
| P | Pseudo-first-order | qₑ (μg/g) | 6.021 | 13.885 |
| | | k₁ (h⁻¹) | 0.01412 | −0.03541 |
| | | R² | 0.004 | 0.561 |
| | Pseudo-second-order | qₑ (μg/g) | 73.04 | −26.11 |
| | | k₂ (h⁻¹) | 0.335 | −0.096 |
| | | R² | 0.999 | 0.998 |
| | Intra-particle diffusion | kᵢ (μg · g⁻¹ · hr^{0.5}) | 7.708 | −4.985 |
| | | C (μg/g) | 44.421 | −8.529 |
| | | R² | 0.231 | 0.768 |
| Cu | Pseudo-first-order | qₑ (μg/g) | 0.224 | 0.178 |
| | | k₁ (h⁻¹) | 0.073 | 0.025 |
| | | R² | 0.206 | 0.026 |
| | Pseudo-second-order | qₑ (μg/g) | 2.093 | 1.289 |
| | | k₂ (h⁻¹) | 45.721 | −23.864 |
| | | R² | 1.000 | 0.999 |
| | Intra-particle diffusion | kᵢ (μg · g⁻¹ · hr^{0.5}) | 0.191 | 0.153 |
| | | C (μg/g) | 1.489 | 0.817 |
| | | R² | 0.185 | 0.29 |
| Pb | Pseudo-first-order | qₑ (μg/g) | 0.229 | 0.210 |
| | | k₁ (h⁻¹) | −0.028 | 0.002 |
| | | R² | 0.026 | 0.000 |
| | Pseudo-second-order | qₑ (μg/g) | 2.209 | 2.101 |
| | | k₂ (h⁻¹) | 15.713 | 9.286 |
| | | R² | 1.000 | 1.000 |
| | Intra-particle diffusion | kᵢ (μg · g⁻¹ · hr^{0.5}) | 0.120 | 0.178 |
| | | C (μg/g) | 1.850 | 1.508 |
| | | R² | 0.054 | 0.155 |
| Zn | Pseudo-first-order | qₑ (μg/g) | 5.589 | 1.721 |
| | | k₁ (h⁻¹) | 0.155 | 0.171 |
| | | R² | 0.779 | 0.646 |
| | Pseudo-second-order | qₑ (μg/g) | 17.296 | 12.155 |
| | | k₂ (h⁻¹) | 0.299 | 0.907 |
| | | R² | 1.000 | 1.000 |
| | Intra-particle diffusion | kᵢ (μg · g⁻¹ · hr^{0.5}) | 2.462 | 1.602 |
| | | C (μg/g) | 8.354 | 6.675 |
| | | R² | 0.45 | 0.389 |

### Column Experiment

Polyvinyl chloride (PVC) pipes with an inner diameter of 7.62 cm were used for performing a column study. The top end of each column was open to receive the influent, whereas the bottom end was capped with a PVC cap that had an effluent port for sampling. In each column, the packing materials comprised three layers (from top to bottom): a layer of glass beads (2.54 cm), a layer of mulch (5.08 cm), and a layer of glass beads (5.08 cm). The glass beads at the bottom served as a supporting layer, whereas the top layer was for distributing the influent uniformly into the underlying mulch layer. Similar to the kinetic experiment, the green engineered mulch was also compared with uncoated mulch in this column experiment, which was loaded in separate columns in duplicates. The synthetic stormwater was prepared in the same way as in the kinetic study. The synthetic stormwater was supplied at the constant flow rate of 8 mL/min from the top of the columns for 7 hr a day for 14 days. Therefore, the total treated volume was equivalent to an annual runoff generated in a catchment with a runoff coefficient of 0.5 (50% of the precipitation is converted to runoff) and an area 20 times larger than the treatment area (see Sidhu, V., Barrett, K., Park, D. Y., Deng, Y., Datta, R., & Sarkar, D. (2020). Wood mulch coated with iron-based water treatment residuals for the abatement of metals and phosphorus in simulated stormwater runoff. Environmental Technology & Innovation, 21, 101214. https://doi.org/10.1016/j.eti.2020.101214, the entire contents of which publication is incorporated herein by reference in its entirety). Synthetic stormwater (600 mL) was added to each column prior to the initiation of the experiment each day. Effluent samples were collected from each column at the 2nd, 4th, and 7th hr, filtered through 0.45-μm nylon syringe filters, and analyzed for P, Cu, Pb, and Zn by the ICP-OES.

### Column Experiment Results

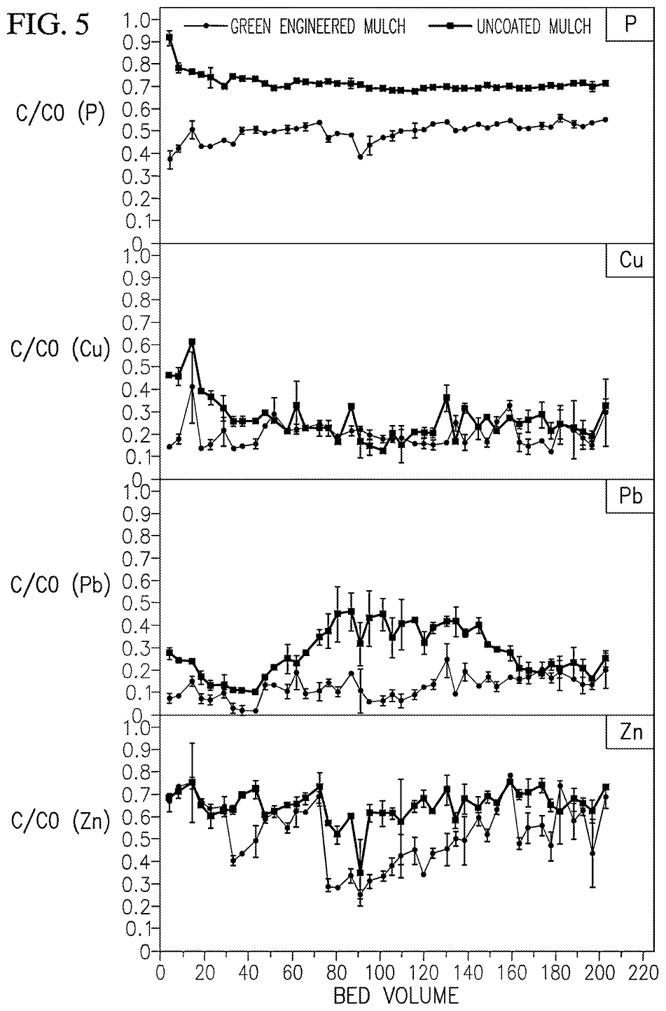

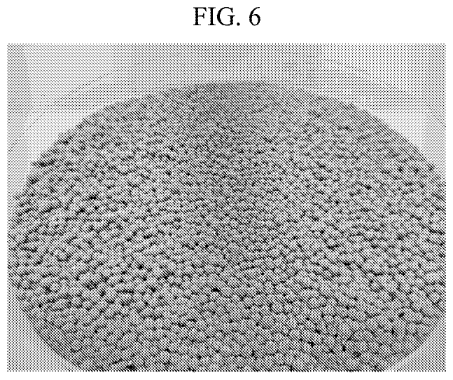

The ratios of effluent concentration to initial concentration (C/C₀) for P, Cu, Pb, and Zn are plotted against the number of bed volume (BV), as shown in FIG. 5. Normalized effluent concentrations of P, Cu, Pb, and Zn versus number of bed volume (BV) from the green engineered mulch and uncoated mulch in the column study.

No P removal by the uncoated much was observed during the study. Instead, P leaching from the uncoated mulch was found, which was in line with the results from the kinetic experiment. In contrast, the green engineered mulch effectively removed P throughout the study. Cu, Pb, and Zn removal by both green engineered mulch and uncoated mulch was observed. However, the green engineered mulch collectively showed higher Cu, Pb, and Zn removal than the uncoated mulch. With the presence of the green engineered mulch, no breakthrough of any pollutants was found over the course of the study. Since the equivalent annual runoff was treated in this experiment, the results showed that the green engineered mulch was capable of removing the target pollutants for more than one year.

### Removal Performance of WTR Granules Experiment

In this study, Cd, Cr, and Ni removal performance of the WTR granules was evaluated via batch adsorption, batch kinetics, and sorption edge experiments. Results showed that both Langmuir and Freundlich models were equally effective in defining Cd and Cr adsorption; however, a better fit was obtained using Freundlich for Ni adsorption. Kinetics of metals adsorption on WTR granules were best described by a pseudo-second-order model compared to pseudo-first-order and intra-particle diffusion models. Neutral to basic pH conditions were favored for Cd and Ni adsorption, while acidic to neutral pH was favored for Cr adsorption.

Preliminary results indicate that WTR granules could effectively remove the above metals as well as phosphorus without impacting water flow. Generating the WTR granules can help divert waste from landfills and can prevent stormwater pollutants from causing adverse environmental impacts. Hence, they could serve as low-cost green filter media for stormwater treatment.

### Method 1: Preparation of Extraction Fluid #1

Add 5.7 ml glacial CH3CH200H to 500 mL of reagent water, add 64.3 mL of 1N NaOH, and dilute to a volume of 1 liter. When correctly prepared, the pH of this fluid will be 4.93±0.05.

### Method 2: Preparation of Extraction Fluid #2

Dilute 5.7 mL glacial CH3CH200H with reagent water to a volume of 1 liter. When correctly prepared, the pH of this fluid will be 2.88±0.05.

These extraction fluids are useful for performing preliminary TCLP evaluations on a minimum 100 gram aliquot of waste. This aliquot may not actually undergo TCLP extraction. These preliminary evaluations include: (1) determination of the percent solids (see Method 3); (2) determination of whether the waste contains insignificant solids and is, therefore, its own extract after filtration; (3) determination of whether the solid portion of the waste requires particle size reduction (see Method 4); and (4) determination of which of the two extraction fluids are to be used for the nonvolatile TCLP extraction of the waste (See Method 5).

### Method 3: Preliminary Determination of Percent Solids

Percent solids is defined as that fraction of a waste sample (as a percentage of the total sample) from which no liquid may be forced out by an applied pressure, as described below. If the waste will obviously yield no liquid when subjected to pressure filtration (i.e., is 100% solids) one can move forward with Method 4.

Method 4: Determination of Whether the Waste Requires Particle Size Reduction and/or Reduction of Particle Size

Using the solid portion of the waste, evaluate the solid for particle size. Particle size reduction is required, unless the solid has a surface area per gram of material equal to or greater than 3.1 cm², or is smaller than 1 cm in its narrowest dimension (i.e., is capable of passing through a 9.5 mm (0.375 inch) standard sieve). If the surface area is smaller or the particle size larger than described above, prepare the solid portion of the waste for extraction by crushing, cutting, or grinding the waste to a surface area or particle size as described above. If the solids are prepared for organic volatiles extraction, special precautions must be taken.

### Method 5: Determination of Appropriate Extraction Fluid:

If the solid content of the waste is greater than or equal to 0.5% and if the sample will be extracted for nonvolatile constituents, determine the appropriate fluid (Methods 1 and 2) for the nonvolatiles extraction as follows:

Initially, it should be noted that TCLP extraction for volatile constituents uses only extraction fluid #1 (see Method 1). Therefore, if TCLP extraction for nonvolatiles this method may be skipped.

Weigh out a small subsample of the solid phase of the waste, reduce the solid (if necessary) to a particle size of approximately 1 mm in diameter or less, and transfer 5.0 grams of the solid phase of the waste to a 500 mL beaker or Erlenmeyer flask.

Add 96.5 ml of reagent water to the beaker, cover with a watchglass, and stir vigorously for 5 minutes using a magnetic stirrer. Measure and record the pH. If the pH is <5.0, use extraction fluid #1 and proceed to Method 6.

If the pH measured above is >5.0, add 3.5 mL 1N HCl, slurry briefly, cover with a watchglass, heat to 50° C., and hold at 50° C. for 10 minutes.

Let the solution cool to room temperature and record the pH. If the pH is <5.0, use extraction fluid #1. If the pH is >5.0, use extraction fluid #2. Proceed to Method 6.

### Method 6: Filtration:

If the waste will obviously yield no liquid when subjected to pressure filtration (i.e., is 100% solid), weigh out a subsample of the waste (100 gram minimum).

If the waste as received passes a 9.5 mm sieve, quantitatively transfer the solid material into the extractor bottle along with the filter used to separate the initial liquid from the solid phase, and proceed. If the waste contains <0.5% dry solids, proceed without such a transfer.

Determine the amount of extraction fluid to add to the extractor vessel as follows: Weight of Extraction fluid=20*percent solids (Method 3)*weight of waste filtered/100

Slowly add this amount of appropriate extraction fluid (Method 5) to the extractor vessel. Close the extractor bottle tightly (it is recommended that Teflon tape be used to ensure a tight seal), secure in rotary agitation device, and rotate at 30±2 rpm for 18±2 hours. Ambient temperature (i.e., temperature of room in which extraction takes place) shall be maintained at 23±2° C. during the extraction period.

NOTE: As agitation continues, pressure may build up within the extractor bottle for some types of wastes (i.e., limed or calcium carbonate containing waste may evolve gases such as carbon dioxide). To relieve excess pressure, the extractor bottle may be periodically opened (i.e., after 15 minutes, 30 minutes, and 1 hour) and vented into a hood.

Following the 18±2 hour extraction, separate the material in the extractor vessel into its component liquid and solid phases by filtering through a new glass fiber filter. For final filtration of the TCLP extract, the glass fiber filter may be changed, if necessary, to facilitate filtration. Filter(s) shall be acid-washed if evaluating the mobility of metals.

### Method 7: Preparation of TCLP Extract

If the waste contained no initial liquid phase, the filtered liquid material obtained from Method 6 is defined as the TCLP extract.

Following collection of the TCLP extract, the pH of the extract should be recorded. Immediately aliquot and preserve the extract for analysis. Metals aliquots must be acidified with nitric acid to pH<2. If precipitation is observed upon addition of nitric acid to a small aliquot of the extract, then the remaining portion of the extract for metals analyses shall not be acidified and the extract shall be analyzed as soon as possible. All other aliquots must be stored under refrigeration (4° C.) until analyzed. The TCLP extract shall be prepared and analyzed according to appropriate analytical methods. TCLP extracts to be analyzed for metals shall be acid digested except in those instances where digestion causes loss of metallic analytes. If an analysis of the undigested extract shows that the concentration of any regulated metallic analyte exceeds the regulatory level, then the waste is hazardous and digestion of the extract is not necessary. However, data on undigested extracts alone cannot be used to demonstrate that the waste is not hazardous. If the individual phases are to be analyzed separately, determine the volume of the individual phases (to +0.5%), conduct the appropriate analyses, and combine the results mathematically by using a simple volume-weighted average:

$$Final Analyte Concentration = ( V 1 ) * ( C 1 ) + ( V 2 ) ( C 2 ) / ( V 1 ) + ( V 2 )$$

Where V1=The volume of the first phase (L); C1=The concentration of the analyte of concern in the first phase (mg/L); V2=The volume of the second phase (L); C2=The concentration of the analyte of concern in the second phase (mg/L).

Finally, Compare the analyte concentrations in the TCLP extract with the levels identified in the appropriate regulations.

### Method 8: Schwertmann, 1964; Fey & LeRoux, 1977; Hodges & Zelazny, 1980

Materials are as follows: Polypropylene centrifuge tubes, 100-mL; Centrifuge; Aluminum foil Analytical balance: 0.00001 g readability. A wire hook attached to the frame of the balance pan is used to hold centrifuge tubes in a vertical position, to reduce weighing errors resulting from variable orientation of the tubes on the balance pan; Shaker; Vacuum desiccator containing dry P₂O₅; Oven: set to 110°+2° C.

Reagents: Ammonium oxalate [(NH₄)₂C₂O₄ H₂O], approximately 0.2 M at pH 3.0: dissolve 28.4 g of reagent-grade ammonium oxalate monohydrate in 900 mL of distilled water, adjust pH to 3.0 using NH₄OH or HCl, and dilute to 1 L; Ammonium carbonate [(NH₄)₂CO₃], approximately 0.5 M: dissolve 47.0 g of reagent-grade ammonium carbonate in 1 L of distilled water; Phosphorus pentoxide (P₂O₅): use reagent-grade powder.

The sample should be a powder, not coarse aggregates. It can have any cation saturation, although NH4 saturation would provide the closest weight comparison after SDA. The sample should have prior treatments to remove carbonates, soluble salts, and organic matter. Generally, clay-sized or whole soil samples are treated, although any sized fraction of interest could be examined. The sample should be dried in a vacuum desiccator over P₂O₅, with an aliquot dried at 110° C. to determine sample moisture content; or the entire sample may be oven dried at 110° C., depending on the drying characteristics of the sample. Operationally, a known amount of sample of approximately 250 mg is weighed into a preweighed (to 0.00001 g) and predried 100-mL polypropylene centrifuge tube. The initial sample weight should be based on a 110° C. oven-dried weight basis. A set of blank tubes should be carried through each procedure to account for any weight loss by the centrifuge tubes upon drying. Care should be exercised in reducing weighing errors by only handling the tubes with forceps, drying all tubes in a 110° C. oven, cooling in a vacuum desiccator containing P₂O₅, and duplicating the time of weighing and exact position of the centrifuge tubes in a vertical position at the center of the balance pan.

To the weighed centrifuge tube containing the sample, add 50 ml of 0.2 M ammonium oxalate solution adjusted to pH 3.0, stopper the centrifuge tube, immediately wrap in aluminum foil to eliminate light, and shake for 2 h on a reciprocating shaker. After the designated time, centrifuge the sample and decant the supernatant solution from the sample. Although not essential for quantification of noncrystalline material, more chemical information can be obtained by saving the supernatant solution in a plastic container and analyzing for at least Al, Fe, and Si.

It will be understood that the embodiments described herein and in the various referenced publications are merely exemplary and that a person skilled in the art may make many variations and modifications without departing from the spirit and scope of the present invention. For instance, related and alternative embodiments and additional manufacturing and use details of the present invention, including materials produced thereby and therefrom, can be gleaned from the documents incorporated herein by reference. All such variations and modifications are intended to be included within the scope of the present invention.

What is claimed is:

1. A method for preparing a green product capable of removing contaminants from stormwater, comprising the steps of:
grinding aluminum-based water treatment residuals into a powder, which comprises ground aluminum-based water treatment residuals;
mixing said powder with a biopolymer solution, thereby creating a coating solution;
coating mulch chips with said coating solution, thereby creating coated mulch chips; and
adding said coated mulch chips into an ionic crosslinker, thereby creating said green product.

2. The method of claim 1, further comprising the step of evaluating said aluminum-based water treatment residuals for toxicity before said grinding step.

3. The method of claim 1, wherein said aluminum-based water treatment residuals comprise aluminum salts.

4. The method of claim 1, further comprising the step of evaluating said aluminum-based water treatment residuals for their potential to remove contaminants from stormwater.

5. The method of claim 1, further comprising the step of sieving said ground aluminum-based water treatment residuals through a 1-mm sieve.

6. The method of claim 1, wherein said biopolymer solution comprises alginate.

7. The method of claim 6, wherein said ground aluminum-based water treatment residuals are added at the ratio of 15% weight/volume to 2% weight/volume alginate biopolymer solution.

8. The method of claim 1, wherein said biopolymer solution comprises chitosan.

9. The method of claim 1, wherein said biopolymer solution comprises pectin.

10. The method of claim 1, wherein said biopolymer solution comprises gellan gum.

11. The method of claim 1, wherein said ionic crosslinker comprises a solution which includes calcium.

12. The method of claim 11, wherein said calcium is prepared by dissolving eggshell powder in acetic acid.

13. The method of claim 12, wherein said eggshell powder is 6% weight/volume and said acetic acid is 10% volume/volume during preparation of said calcium.

14. The method of claim 1, further comprising the step of testing said ground aluminum-based water treatment residuals for toxicity.

15. The method of claim 1, further comprising the step of washing said ground aluminum-based water treatment residuals with an acid.

16. The method of claim 15, wherein said acid is acetic acid.

17. The method of claim 1, further comprising the step of evaluating said ground aluminum-based water treatment residuals for their sorbent/reactivity potential.

18. The method of claim 17, wherein said evaluating step is performed based on oxalate-extractable aluminum concentration.

19. The method of claim 17, further comprising the step of measuring the concentration of amorphous aluminum oxide in said ground aluminum-based water treatment residuals.

20. The method of claim 17, further comprising the step of measuring the concentration of amorphous aluminum hydroxide in said ground aluminum-based water treatment residuals

21. The method of claim 1, further comprising the step of washing said green product, thereby creating a washed green product.

22. The method of claim 21, further comprising the step of drying said washed green product.

23. The method of claim 1, wherein said mulch chips are provided for the performance of said coating step at a ratio of 45% weight/volume.

24. The method of claim 1, further comprising the step of applying said green product on the ground of a bioretention system.

25. The method of claim 1, further comprising the step of retrofitting stormwater best management processes by replacing regular mulch with said green product.

26. The method of claim 1, further comprising the step of drying said aluminum-based water treatment residuals prior to said grinding step.

27. A green-engineered mulch product made in accordance with the method of claim 1.

28. A coating adapted for application to mulch chips and the like, comprising a biopolymer; ground aluminum-based water treatment residuals; and an ionic crosslinker binding said biopolymer and said ground aluminum-based water treatment residuals together.

29. The coating of claim 28, wherein said coating does not allow water to pass through it.

30. The coating of claim 28, wherein said biopolymer comprises alginate.

31. The coating of claim 28, wherein said biopolymer comprises chitosan.

32. The coating of claim 28, wherein said biopolymer comprises pectin.

33. The coating of claim 28, wherein said biopolymer comprises gellan gum.

34. The coating of claim 28, wherein said ionic crosslinker comprises calcium.

35. In combination: mulch chips; and a coating applied to said mulch chips, said coating comprising a biopolymer, ground aluminum-based water treatment residuals and an ionic crosslinker.

36. The combination of claim 35, wherein said biopolymer comprises alginate.

37. The combination of claim 35, wherein said biopolymer comprises chitosan.

38. The combination of claim 35, wherein said biopolymer comprises pectin.

39. The combination of claim 35, wherein said biopolymer comprises gellan gum.

40. The combination of claim 35, wherein said ionic crosslinker comprises calcium.

41. The combination of claim 35, wherein said mulch chips are applied to the coating at a ratio of 45% weight/volume.
